(19) United States
(12) Patent Application Publication
(10) Pub. No.: US 2008/0083707 A1
(43) Pub. Date: Apr. 10, 2008

(54) Stud holder

(75) Inventor: Alexander Schug, Staufenberg (DE)

Correspondence Address: HARNESS, DICKEY & PIERCE, P.L.C., P.O. BOX 828, BLOOMFIELD HILLS, MI, 48303, US

(73) Assignee: NEWFREY LLC, Newark, DE (US)

(21) Appl. No.: 11/903,130

(22) Filed: Sep. 20, 2007

(30) Foreign Application Priority Data
Oct. 5, 2006 (DE) 10 2006 048 320.0

(51) Int. Cl. B23K 9/20

(52) U.S. Cl. 219/98

(57) ABSTRACT

A holder for a stud portion of a stud has a polygonal cross section, in particular for use in an apparatus for stud welding. The apparatus includes a fastening portion fixed to the stud-welding apparatus, and having a retaining portion which has a multiplicity of retaining tongues which extend substantially in a longitudinal direction. The retaining tongues can be elastically bent in a direction transverse to the longitudinal direction in order to receive and elastically retain the polygonal stud portion between them. At least two of the retaining tongues form a slot between them. At least a portion of the slot runs in a helical manner.

### CROSS-REFERENCE TO RELATED APPLICATIONS

This application is a continuation of German Patent Application No. 10 2006 048 320.0, filed Oct. 5, 2006. The disclosure of the above application is incorporated herein by reference.

### FIELD

The present invention relates to a holder for a stud portion of a stud, which stud portion has a polygonal cross section, in particular for use in an apparatus for stud welding, having a fastening portion which can be fixed to the stud-welding apparatus, and having a retaining portion which has a multiplicity of retaining tongues which extend substantially in a longitudinal direction and can be elastically bent in a direction transverse to said longitudinal direction in order to receive and elastically retain the polygonal stud portion between them, with at least two of the retaining tongues forming a slot between them.

### BACKGROUND

Holders of this type for welding studs with an approximately square cross section are known. Such a holder substantially has four tongues which each extend parallel to the longitudinal direction and between them define a substantially square cross section for receiving the corresponding welding stud. In general, the present invention relates to the field of short-time arc welding, also known as stud welding. In this process, a welding stud is welded onto a metal sheet by an arc being generated between the stud and the metal sheet. As a result, the areas which are opposite one another are fused. The stud is then lowered onto the workpiece and the arc is extinguished, with the welding current being switched off. The fusing melts solidify, with the result that the stud is firmly fixed on the metal sheet. The stud on the metal sheet can then serve as an anchor for fastening elements (clips etc.) in vehicle-body construction, for example. Welding studs of this type generally have a flange portion. This flange portion may be circular but may also be of polygonal design.

The known holder for a square stud contains four retaining tongues which can elastically receive and retain the square stud between them. At the same time, the holder serves as an electrical conductor by means of which the welding current is conducted to the stud. In the known holder for square studs, the studs have to be introduced into the holder in the correct position as seen in the direction of rotation about the longitudinal axis. Otherwise, the stud bears against the inside of the retaining tongues only at points or lines. This may lead to a comparatively high electrical resistance at the junction of holder and stud, and this makes it considerably more difficult to apply the welding current to the stud.

### SUMMARY

Against this background, the object of the invention is to specify an improved holder for studs with a polygonal stud portion. In the case of the abovementioned holder for a stud portion of a stud, which stud portion has a polygonal cross section, this object is achieved in that at least a portion of the slot runs in a helical manner.

This measure means it is possible that introduction of a stud that is not exactly aligned with the retaining tongues in a direction of rotation about the longitudinal axis will, with a relatively high degree of probability, lead to a corner of the polygonal stud portion engaging in the slot. As a result of this, the current supply can be improved since a greater number of contact points or lines can be realized when a corner of the polygonal stud portion engages in the slot. The object is therefore fully achieved.

It is particularly preferred for the retaining tongues to have a retaining region which extends in the longitudinal direction and within which the polygonal stud portion can be displaced in the longitudinal direction when it is accommodated in the holder. In this case, the stud may generally be supplied via the fastening portion which is then designed in a hollow fashion for this purpose. As an alternative, it is also of course feasible to introduce the stud into the retaining region from the front, that is to say from the region of the free ends of the retaining tongues.

The retaining region has a certain length in the longitudinal direction, which length corresponds to the path which the stud travels when it is inserted into the holder. In this case, it is particularly advantageous for the slot to extend within the retaining region in the circumferential direction at such an angle that one corner of the polygonal stud portion is inevitably aligned with the slot when the stud is received. In other words, the slot is formed in such a helical manner that one corner of the polygonal stud portion is always guaranteed to engage in the slot during introduction of the stud, and a larger contact area can be realized as a result.

Overall, it is also advantageous for the retaining tongues to form at least two slots, with the gradient of the helical profiles being selected such that the slots coincide at least one point in a projection in the longitudinal direction. In this way, it is always guaranteed that one corner is aligned with a slot, until the stud is in the retaining position in the holder, completely independently of the rotary position of the stud at the time, when said stud is supplied to the holder.

According to a further preferred embodiment, the number of retaining tongues corresponds to the number of corners of the polygonal stud portion. This means that, in the retaining position, all of the corners of the polygonal retaining portion engage in corresponding slots between the retaining tongues, independently of the respective rotary position of the stud when it is supplied. However, it is generally also feasible for the number of retaining tongues to be greater than the number of corners or to be less than the number of corners. However, it is always preferred for the ratio between the number of retaining tongues and the number of corners to be a natural number, preferably an even number.

According to a further preferred embodiment, the retaining tongues together substantially define a circle when viewed in cross section. In this way, the retaining portion can be formed in a comparatively cost-effective manner from a tubular portion in which helical slots can be made.

Overall, it is likewise preferred for the holder to be of integral design. In this way, the holder can be produced in a cost-effective manner and can conduct the comparatively high welding currents in an effective manner. Overall, it is also preferred for the holder to be formed from an electrically conductive material for this reason.

The slot or the slots in the retaining portion are preferably radially continuous slots. However, they may also be non-radially continuous grooves which are formed on the inner circumference of the retaining tongues. It goes without saying that the abovementioned features and those still to be explained below can not only be used in the respectively specified combination but also in other combinations or on their own, without departing from the scope of the present invention.

### DRAWINGS

Exemplary embodiments of the invention are explained in greater detail in the following description and are illustrated in the drawing, in which:

FIG. 1 shows a side elevational view of a holder according to one embodiment of the present invention;

FIG. 2 shows a front elevational view of the holder from FIG. 1 with the stud inserted; and

FIG. 3 is a cross-sectional side elevational view taken along line III-III in FIG. 2.

### DETAILED DESCRIPTION

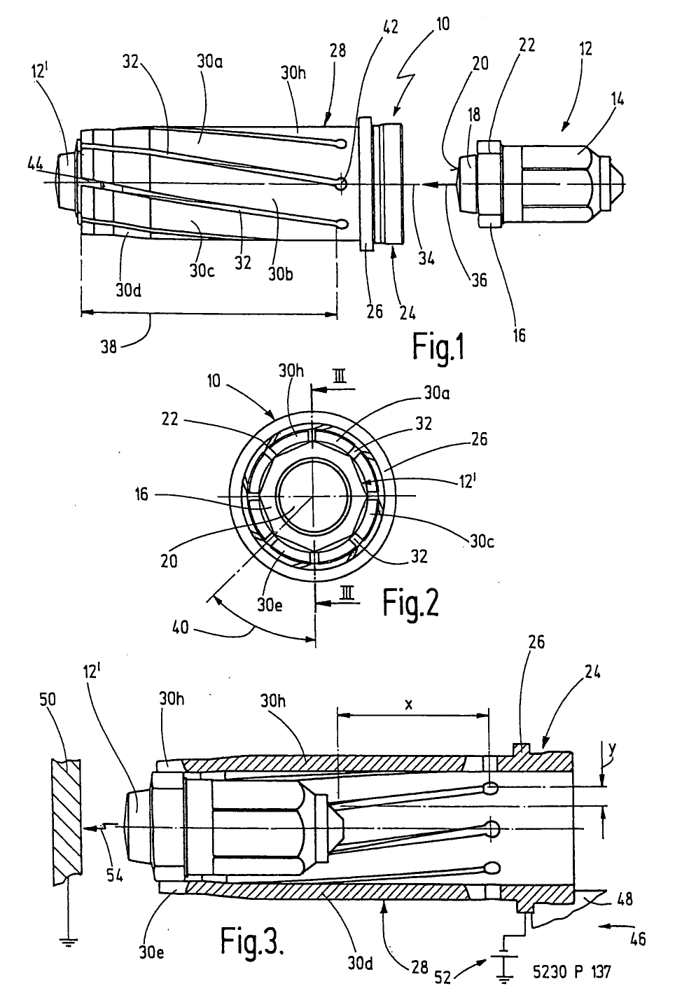

In FIGS. 1 to 3, an embodiment of an inventive holder is in general denoted by 10. The holder 10 is an integral component which is composed of an electrically conductive and preferably at least slightly elastically deformable material, for example a steel alloy. The holder 10 serves to accommodate a stud 12.

The stud 12 has a shaft portion 14 which may be of any desired design. The stud 12 also has a polygonal flange portion 16 whose diameter is greater than that of the shaft portion 14. Finally, the stud 12 has a welding region 18 which is formed on the side of the flange portion 16 opposite the shaft portion 14 and which has a smaller diameter than the flange portion 16. At its axial end, the welding region 18 has a slightly conically running welding area 20 which can melt during the arc-welding process. Furthermore, one corner of the flange portion 16 which is octagonal in the present case is indicated by 22.

The holder 10 is generally of hollow-cylindrical design and has a fastening portion 24 on which an annular flange 26 is formed. The fastening portion 24 serves to fasten said holder to a welding head of a stud-welding apparatus, as will be explained further below.

The holder 10 also has a retaining portion 28 with a multiplicity of (in the present case eight) retaining tongues 30 between which slots 32 are formed. The retaining tongues 30 generally extend in the direction of a longitudinal axis 34 of the holder 10. In general, the retaining portion 28 has a circular cross section, with the slots 32 not running parallel to the longitudinal axis 34 but rather helically around said longitudinal axis. The eight retaining tongues 30a to 30h are each formed in the manner of a cantilever which is fixed in the region of the fastening portion 24.

For the purpose of insertion into the holder 10, a stud 12 is introduced from the rear via the fastening portion 24, as is schematically illustrated by an arrow 36 in FIG. 1. During introduction, the flange portion 16 passes over substantially the entire length of the retaining tongues. The axial length of the retaining tongues 30 therefore corresponds to a retaining region 38 within which the flange portion 16 can be displaced in the longitudinal direction 34 when it is accommodated in the holder 10.

The slots 32 are formed in such a way that, from one end of the retaining region 38 to the other end of the retaining region 38, they pass through an angle 40 which in the present case is 45° (360° divided by the number of retaining tongues (=8)=45°). This in turn means that a starting point 42 of a slot 32 between two retaining tongues 30a, 30b coincides with an end point 44 of an adjacent slot 32 in a projection in the longitudinal direction, with the end point 44 being formed in the region of the free ends of the retaining tongues 30b, 30c.

This ensures that the corners 22 engage in the slots 32, independently of the respective rotary position of the stud 12 when it is introduced into the holder 10. Provided that this happens, for example halfway down the retaining region 38, the stud 12 is carried along by the slots 32 in the further process, so that the corners 22 are always situated in the region of slots 32 in the retaining position of the stud 12′, which position is shown in FIG. 1.

In this way, a greater number of contact points or lines can be produced in the region of the slots, so that wear on the stud holder can be reduced and welding can be performed with a lower current intensity. In general, it is also possible to use a holder of this type to also hold other studs in an optimum manner, for example square studs or hexagonal studs, but also studs with any other type of polygonal stud portion, since one corner of the polygonal stud portion 16 will, with a relatively high degree of probability, engage in a slot in almost every case.

What is claimed is:

1. A holder for holding a portion of a fastener, comprising:
a hollow body including a retaining portion having a polygonal-shaped cross section, the retaining portion including:
a plurality of retaining tongues extending in a substantially longitudinal direction, the retaining tongues elastically bendable in a direction transverse to the longitudinal direction to receive and elastically retain a polygonal-shaped stud portion between them; and
a slot separating at least two of the retaining tongues, wherein at least a portion of the slot has a helical orientation.

2. The holder of claim 1, wherein the retaining tongues further include a retaining region extending in the longitudinal direction and within which a polygonal-shaped portion of a fastener is displaceable in the longitudinal direction when the fastener is accommodated in the holder.

3. The holder of claim 2, wherein the slot extends throughout a length of the retaining region in a circumferential direction defining an angle such that one of a plurality of corners of the polygonal-shaped portion of the fastener is alignable with the slot when the fastener is longitudinally received in the retaining region.

4. The holder of claim 3, wherein the holder is adapted to retain the fastener which is configured as a weld stud including a flange portion having the plurality of corners created therein.

5. The holder of claim 4, wherein a quantity of the plurality of retaining tongues corresponds to a quantity of the plurality of corners of the fastener.

6. The holder of claim 3, wherein the angle is determined by dividing 360 degrees by a quantity of the retaining tongues.

7. The holder of claim 1, wherein the body further comprises a hollow fastening portion adapted to be fixed to a stud-welding apparatus.

8. The holder of claim 7, wherein the retaining portion and the fastening portion are both coaxially aligned with respect to a longitudinal axis of the body such that a stud can be slidably received in each of the retaining and fastening portions in the longitudinal direction and parallel with the longitudinal axis.

9. The holder of claim 1, wherein the plurality of retaining tongues define at least two slots, having a gradient of the helical orientation selected such that each of the at least two slots coincide with at least one point in a projection in the longitudinal direction.

10. The holder of claim 1, wherein the plurality of retaining tongues together substantially define a circle when viewed in cross section.

11. The holder of claim 1, wherein the body defines a homogenous member made from an electrically conductive material.

12. A holder adapted for temporarily retaining a polygonal-shaped portion of a stud, comprising:
a body having a polygonal-shaped cross section adapted for use in an apparatus for stud welding, the body including:
a fastening portion fixable to the stud-welding apparatus; and
a retaining portion, including:
a plurality of retaining tongues extending in a longitudinal direction, the retaining tongues elastically bendable in a direction transverse to the longitudinal direction to receive and elastically retain a polygonal-shaped portion of a stud between them; and
a slot separating at least two of the retaining tongues, wherein at least a portion of the slot has a helical orientation such that a corner of the polygonal-shaped portion of the stud will be engaged within the slot for at least a partial length of the slot when the stud is longitudinally received within the retaining portion.

13. The holder of claim 12, wherein the retaining tongues are positioned in a retaining region of the retaining portion fixed to the fastening portion and cantilevered in the longitudinal direction away from the fastening portion and within which a polygonal-shaped portion of a fastener is displaceable in the longitudinal direction when the fastener is accommodated in the holder.

14. The holder of claim 13, wherein the slot extends throughout a length of the retaining region in a circumferential direction defining an angle such that one of a plurality of corners of the polygonal-shaped portion of the fastener is alignable with the slot when the fastener is received in the retaining region.

15. The holder of claim 14, wherein the holder is adapted to retain the fastener which is configured as a weld stud including a flange portion having the plurality of corners created therein.

16. The holder of claim 14, wherein a quantity of the plurality of retaining tongues corresponds to a quantity of the plurality of corners of the fastener.

17. The holder of claim 3, wherein a starting point of the slot of a first one the at least two of the retaining tongues coincides with an end point of a proximate one of the at least two retaining tongues in a projection in the longitudinal direction.

18. A system for holding a portion of a fastener, comprising:
a hollow holder including a retaining portion having a polygonal-shaped cross section, the retaining portion also including:
a plurality of retaining tongues extending in a substantially longitudinal direction, the retaining tongues elastically bendable in a direction transverse to the longitudinal direction; and
a plurality of slots each separating proximate ones of the retaining tongues, wherein at least a portion of each slot has a helical orientation; and
a fastener configured as a weld stud including a flange portion having a plurality of corners, at least one of the corners receivable in one of the slots and the flange portion operable to elastically bias the retaining tongues to temporarily retain the fastener between the retaining tongues when the fastener is longitudinally received in the holder.

19. The system of claim 18, wherein the stud further comprises:
a conically running welding area extending from a welding region; and
the flange portion having the plurality of corners created therein having a diameter larger than the welding region.

20. The system of claim 18, wherein each of the slots is a radially continuous through-opening created in the retaining portion.

21. The system of claim 18, wherein each of the slots is a non-radially continuous groove created on an inner circumference of the retaining tongues.

22. A method for using a holder for temporarily retaining a polygonal-shaped portion of a stud, the holder including a plurality of longitudinally configured, elastically deflectable retaining tongues, the stud having a plurality of corners on the polygonal-shaped portion, the method comprising:
creating a plurality of slots in a retaining region of the holder, each of the plurality of slots positioned between proximate ones of the retaining tongues;
shaping each of the plurality of slots in a helical configuration;
inserting the stud into a hollow center portion of the holder to elastically bias the retaining tongues into contact with the stud; and
continuing to longitudinally insert the stud until one of the corners is received in one of the slots to increase a surface area of the stud in contact with the holder.

23. The method of claim 22, further comprising cantilevering the retaining tongues from a fastening portion of the stud such that a free end of the retaining tongues faces away from the fastening portion.

24. The method of claim 23, further comprising creating each of the slots such that each slot passes through an angle from an end of the retaining region to a free end of the retaining tongues.

25. The method of claim 24, further comprising determining the angle by dividing 360 degrees by a quantity of the retaining tongues.
